(19) United States
(12) Patent Application Publication
(10) Pub. No.: US 2021/0383332 A1
(43) Pub. Date: Dec. 9, 2021

(54) VEHICLE MAINTENANCE SUPPORT DEVICE, VEHICLE MAINTENANCE SUPPORT METHOD, AND COMPUTER-READABLE MEDIUM

(71) Applicant: BROADLEAF CO., LTD., Shinagawa-ku, Tokyo (JP)

(72) Inventors: Ryota SOKEI, Shinagawa-ku, Tokyo (JP); Isamu IWAMOTO, Shinagawa-ku, Tokyo (JP); Ryosuke HIROSE, Shinagawa-ku, Tokyo (JP); Ikumi MABUCHI, Shinagawa-ku, Tokyo (JP); Emi HIRAYAMA, Shinagawa-ku, Tokyo (JP); Hitoshi NAKAMURA, Shinagawa-ku, Tokyo (JP); Ken NAKAMURA, Shinagawa-ku, Tokyo (JP)

(73) Assignee: BROADLEAF CO., LTD., Shinagawa-ku, Tokyo (JP)

(21) Appl. No.: 17/280,489

(22) PCT Filed: Sep. 27, 2019
(86) PCT No.: PCT/JP2019/038404

§ 371 Date: Mar. 26, 2021

(30) Foreign Application Priority Data
Sep. 28, 2018 (JP) 2018-184360

(51) Int. Cl. G06Q 10/00; G06F 3/0482; G06Q 10/08; G06F 16/21; B60S 5/00

(52) U.S. Cl. CPC G06Q 10/20; G06F 3/0482; B60S 5/00; G06F 16/212; G06Q 10/0875

(57) ABSTRACT

A vehicle maintenance support device for supporting creation of slips related to vehicle maintenance includes: a storage unit configured to store service-component correspondence data representing a correspondence relation between service contents related to the vehicle maintenance, and candidates for vehicle components required depending on the service contents; an entry task display unit configured to receive input of a certain service content by a user's operation, and display inputted service content on a display screen of a user terminal; a required-component presentation unit configured to present candidates for required vehicle components on the display screen, by referring to the service-component correspondence data, using the inputted service content as a key; and a selected-component display unit configured to receive selection of certain vehicle components from the presented vehicle component candidates by the user's operation, and display the selected vehicle components on the display screen in association with the service content.

### TECHNICAL FIELD

The present invention relates to a vehicle maintenance support device, a vehicle maintenance support method, and a vehicle maintenance support program and more particularly, to a vehicle maintenance support device, a vehicle maintenance support method, and a vehicle maintenance support program for supporting creation of slips related to vehicle maintenance.

### BACKGROUND ART

In general, there are vehicle test systems in which a regular vehicle test is mandatory to ensure safe operation of vehicles. The vehicle test is to check if there is any problem in terms of appearance, safety, and pollution, on the basis of safety standards set by the Ministry of Land, Infrastructure, Transport and Tourism, and for example, in the case of automobiles, once every two years, the conditions of the automobiles should be tested in the Transportation Bureau or designated vehicle inspection and maintenance facilities licensed by the Transportation Bureau. Further, for automobiles which pass the test, automobile inspection certificates valid for two years are issued or updated.

Also, before undergoing the vehicle test, automobiles undergo regular inspection and maintenance which is generally carried out at automobile inspection and maintenance facilities and automobile dealerships (dealers). Of them, there are inspection and maintenance facilities and dealerships approved by the designated vehicle inspection and maintenance facilities, and the number of places for carrying out regular inspection and maintenance and the vehicle test together is increasing.

In recent years, more and more automobile inspection and maintenance facilities and automobile dealerships have adopted a witnessed vehicle test system to provide effective services to customers.

The witnessed vehicle test has merits that the vehicle test is completed in a relatively short time, and the vehicle test cost is low, and it is possible to receive an explanation while actually and visually checking in person.

Meantime, the maintenance business operators (workers) create slips (for example, estimates) related to repair services, change services, and change components required for vehicle maintenance as the result of inspection. Vehicle maintenance support systems for supporting creation of slips have been proposed (see Patent Literature 1 for instance).

According to the vehicle inspecting system of Patent Literature 1, it is possible for maintenance business operators to create an estimate while selecting vehicle components required as the result of vehicle inspection, using a user terminal. Specifically, the system has a component selection file including an advance preparation pattern file including component data items and service fee data items associated with each other, a candidate component pattern file, and so on, so it is possible to select vehicle components required as the result of vehicle inspection, in associated with the component names, the unit component costs, and the service content fees required for individual inspection items.

### CITATION LIST

### Patent Literature

Patent Literature 1: Japanese Patent Application Laid-Open No. 2006-131002

### SUMMARY OF INVENTION

### Technical Problem

According to vehicle inspecting systems of the related art such as Patent Literature 1, a maintenance business operator appropriately inputs or selects service contents and vehicle components required as the result of vehicle inspection, on a slip creation screen displayed on a user terminal, such that slip data which is a list of service contents and vehicle components is completed; however, the corresponding slip data is not a display specification from which the relation between service contents and vehicle components required depending on the service contents is easily grasped.

For this reason, vehicle maintenance support devices fix making it easy for maintenance business operators to easily grasp the relation between required service contents and required vehicle components when creating slip data on a slip creation screen have been desired.

Further, in vehicle inspecting systems of the related art, there was no system in which if a maintenance business operator inputs a service content required as the result of vehicle inspection, candidates for each vehicle component required depending on the corresponding service content are displayed and the priorities of the candidates for the corresponding vehicle component are customized for each user.

For this reason, a vehicle maintenance support device which has functions customized for individual users on a slip creation screen such that maintenance business operators can efficiently create slip data has been desired.

The present invention was made in view of this circumstances, and an object of the present invention is to provide a vehicle maintenance support device, a vehicle maintenance support method, and a vehicle maintenance support program for making it easy for a user such as a maintenance business operator to grasp the relation between required service contents and required vehicle components when creating slip data on the display screen of a user terminal.

Also, another object of the present invention is to provide a vehicle maintenance support device, a vehicle maintenance support method, and a vehicle maintenance support program for making it possible for a user such as a maintenance business operator to efficiently create slip data on the display screen of a user terminal.

### Solution to Problem

In order to solve the above-mentioned problems, a vehicle maintenance support device of the present invention is a vehicle maintenance support device for supporting creation of slips related to vehicle maintenance which includes: a storage unit configured to store service-component correspondence data representing a correspondence relation between service contents related to the vehicle maintenance, and candidates for vehicle components required depending on the service contents; an entry task display unit configured to receive input of a certain service content by a user's operation, and displays the inputted service content on a display screen of a user terminal; a required-component presentation unit configured to present candidates for required vehicle components on the display screen, by referring to the service-component correspondence data, using the inputted service content as a key; and a selected-component display unit configured to receive selection of certain vehicle components from the presented vehicle component candidates by the user's operation, and display the selected vehicle components on the display screen in association with the service content.

According to the above-mentioned configuration, it is possible to implement a vehicle maintenance support device for making it easy for a user such as a maintenance business operator to grasp the relation between required service contents and required vehicle components when creating, slip data on the display screen of a user terminal.

To be specific, on the occasion of creating slip data, the selected-component display unit displays selected vehicle components on the display screen of the user terminal, in association with service contents. Therefore, it becomes easy for maintenance business operators and so on to grasp the relation between service contents related to vehicle maintenance and vehicle components required depending on the service contents.

Also, on the occasion of creating slip data, the required-component presentation unit presents candidates for required vehicle components on the display screen, using inputted service contents as keys. Therefore, maintenance business operators and so on can efficiently create slip data on the display screens of user terminals.

In this case, the selected-component display unit may be configured to display information on each of the vehicle components on the display screen such that it is arranged together with the service content in a row, and display information on the vehicle components so as to be indented with respect to the service content.

According, to the above-mentioned configuration, maintenance business operators and so on can efficiently create easier slip data on the display screens of user terminals.

In this case, the storage unit may be configured to store selected-component log data representing history information of the vehicle components selected by user's operations, and the vehicle maintenance support device may further include a user selection frequency calculator configured to calculate user selection frequencies of individual vehicle components selected as vehicle components required for a certain service content, with reference to the selected-component log data, and the required-component presentation unit may be configured to present candidates for required vehicle components on the display screen, according to priorities based on the calculated user selection frequencies.

According to the above-mentioned configuration, the vehicle maintenance support device has functions customized for individual users on the slip creation screen, so maintenance business operators can efficiently create slip data.

In this case, the storage unit may be configured to store a plurality of past slip data items including vehicle information on vehicles, information on the service contents and the vehicle components related to vehicle maintenance, and the vehicle maintenance support device may further include a service-component relevance calculator configured to count a frequency of use of each of the service contents and the vehicle components, with reference to the plurality of slip data items, and calculates degrees of relevance based on degrees of co-occurrence between the service contents and the vehicle components in each vehicle information item, and a related-component presentation unit configured to present candidates for service contents and/or vehicle components related to the combinations of the service content inputted or selected by a user's operation and the vehicle components on the display screen, according to levels of calculated relevance based on the degrees of co-occurrence, by referring to the vehicle information inputted in advance by the user's operation as an attribute value, and the related-component presentation unit may be configured to present candidates for related service contents and/or vehicle components in a descending order of the degrees of calculated relevance based on the degrees of co-occurrence.

According to the above-mentioned configuration, if a maintenance business operator or the like inputs a service content required as the result of vehicle inspection, on the slip creation screen, candidates for vehicle components required depending on the corresponding service content are displayed, and candidates for service contents and/or vehicle components related to the combinations of the corresponding service content and the vehicle components are displayed. Therefore, maintenance business operators can efficiently create slip data.

In this case, the storage unit may be configured to store search dictionary data related to the service contents, and entry task log data representing history information of service contents inputted by user's operations, and the vehicle maintenance support device may further include a user entry frequency calculator configured to calculate a frequency of the user's input of each inputted service content with reference to the entry task log data, and an entry candidate presentation unit configured to present service content candidates including some characters of a certain service content with reference to the search dictionary data when receiving input of the some characters by the user's operation, and the entry candidate presentation unit may be configured to present the service content candidates according to priorities based on the calculated frequencies of user's input.

According to the above-mentioned configuration, maintenance business operators and so on can efficiently create easier slip data on the display screens of user terminals.

Also, it is possible to implement a vehicle maintenance support method for supporting creation of slips related to vehicle maintenance, wherein a computer including a storage unit storing service-component correspondence data representing the correspondence relation between service contents related to the vehicle maintenance, and candidates for vehicle components required depending on the service contents executes an entry task display step of receiving input of a certain service content by a user's operation, and displaying the inputted service content on a display screen of a user terminal, a required-component presentation step of presenting candidates for required vehicle components on the display screen, by referring to the service-component correspondence data, using the inputted service content as a key, and a selected-component display step of receiving selection of certain vehicle components from the presented vehicle component candidates by a user's operation, and displaying the selected vehicle components on the display screen in association with the service content.

Also, it is possible to implement a vehicle maintenance support program for making a computer serving as a vehicle maintenance support device for supporting creation of slips related to vehicle maintenance execute an entry task display process of receiving input of a certain service content by a user's operation, and displaying the inputted service content on the display screen of a user terminal, a required-component presentation process of presenting candidates for required vehicle components on a display screen, by referring to service-component correspondence data representing the correspondence relation between service contents related to the vehicle maintenance and candidates for vehicle components required depending on the service contents, using the inputted service content as a key, and a selected-component display process of receiving selection of certain vehicle components from the presented vehicle component candidates by a user's operation, and displaying the selected vehicle components on the display screen in association with the service content.

### Advantageous Effects of Invention

According to the vehicle maintenance support device, the vehicle maintenance support method, and the vehicle maintenance support program of the present invention, it becomes easy for users such as maintenance business operators to grasp the relation between service contents and vehicle components required depending on the service contents when creating slip data on the display screen of a user terminal.

Also, it becomes possible for users such as maintenance business operators to efficiently create slip data on the display screen of a user terminal.

### BRIEF DESCRIPTION OF DRAWINGS

FIG. 1 is a view illustrating the overall configuration of a vehicle maintenance support system of the present invention.

FIG. 2 is a view illustrating the software configurations of a vehicle maintenance support device and a user terminal.

FIG. 3 is a view illustrating an example of service-component correspondence data.

FIG. 4 is a view illustrating an example of slip data.

FIG. 5 is a view for explaining an example of an entry task display process.

FIG. 6 is a view for explaining examples of a required-component presentation process and a related-component presentation process.

FIG. 7 is a view for explaining an example of a selected-component display process.

FIG. 8 is a view for explaining an example of an entry support display process.

FIG. 9 is a flow chart illustrating an example of processing of a vehicle maintenance support program of the present invention.

### DESCRIPTION OF EMBODIMENTS

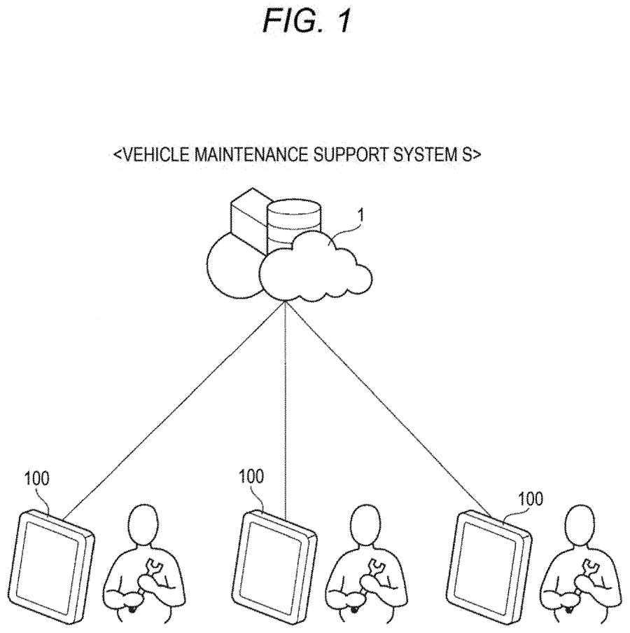

Hereinafter, an embodiment of the present invention will be described with reference to FIG. 1 to FIG. 9.

The present embodiment relates to an invention which is a vehicle maintenance support device for supporting creation of slips related to vehicle maintenance and is characterized by including a storage unit that stores service-component correspondence data representing the correspondence relation between service contents related to vehicle maintenance and candidates for vehicle components required depending on the service contents, an entry task display unit that receives input of a certain service content by a user's operation and displays the inputted service content on the display screen of a user terminal, a required-component presentation unit that presents candidates for required vehicle components on the display screen by referring to the service-component correspondence data, using the inputted service content as a key, and a selected-component display unit that receives selection of certain vehicle components from the presented vehicle component candidates by a user's operation and display the selected vehicle components on the display screen in association with the service content.

The overall configuration of a vehicle maintenance support system S which is the present embodiment is shown in FIG. 1.

The vehicle maintenance support system S is mainly composed of a vehicle maintenance support device 1 for supporting creation of slips (slip data) related to vehicle maintenance, and a user terminal 100 that is connected to the vehicle maintenance support device 1 through a network and is held by a user such as a maintenance business operator.

Herein, “slips” are various documents for recording, calculating, or reporting details of transactions, and include not only estimates and invoices but also statements of delivery, receipts, paying-in slips, paying-out slips, etc.

The vehicle maintenance support device 1 is a cloud server which provides software services to the user terminal 100 connected thereto through a network.

Specifically, the vehicle maintenance support device provides software services related to slip creation tasks to the user terminal 100. To be specific, the vehicle maintenance support device presents a slip creation screen on the user terminal 100, and updates the slip creation screen in response to reception of input or selection by a user's operation, to support the user such that the user can efficiently create slip data.

Also, the vehicle maintenance support device 1 has a function of serving as a customer management data server for managing automobile inspection certificate registration data representing contents of automobile inspection certificates obtained from customers which are vehicle test clients, and a function of serving as a data server for slip creation that is for collectively managing various programs and a variety of data for supporting creation of slips related to vehicle maintenance.

The user terminal 100 is a portable information terminal which can be operated by the user such as a maintenance business operator, and is specifically a computer such as a PC, a tablet terminal, a smart phone, etc.

The user terminal 100 can be connected to the vehicle maintenance support device 1 through the network to receive software services from the vehicle maintenance support device 1.

Specifically, the user terminal cam create slip data on the display screen by receiving input or selection of service contents related to vehicle maintenance and vehicle components required depending on the service contents by user's operations, and output the completed slip data as a slip.

<Hardware Configuration of Vehicle Maintenance Support Device>

The vehicle maintenance support device 1 is a computer including a CPU serving as a processor for arithmetic processing on data and control, and a ROM, a RAM, and an HDD (SSD) serving as storage devices, and a communication interface for performing transmission and reception of information data through a home network or the Internet.

Also, the vehicle maintenance support device 1 further includes a display device for displaying character or image information to be displayed in a predetermined form, an input device for user's input operations to input certain commands to the CPU, a storage medium device such as an external hard disk drive, and a printer for outputting character or image information.

The user terminal 100 also is a computer having the same hardware configuration.

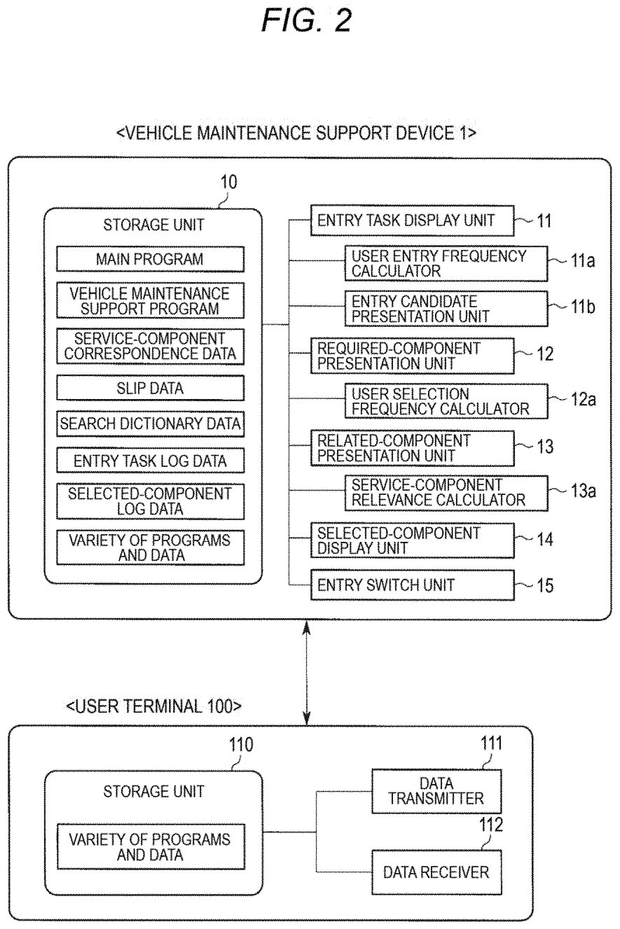

The ROM, the HDD, and the external storage device included in the vehicle maintenance support device 1 store a vehicle maintenance support program in addition to a main program for executing functions required to serve as a computer, as shown in FIG. 2, and these programs are executed by the CPU, whereby the functions of the vehicle maintenance support device 1 are fulfilled.

<Software Configuration of Vehicle Maintenance Support Device>

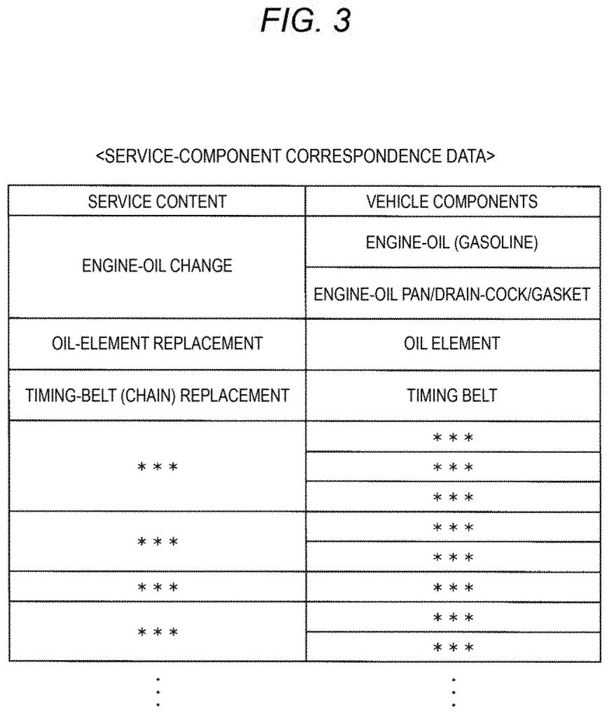

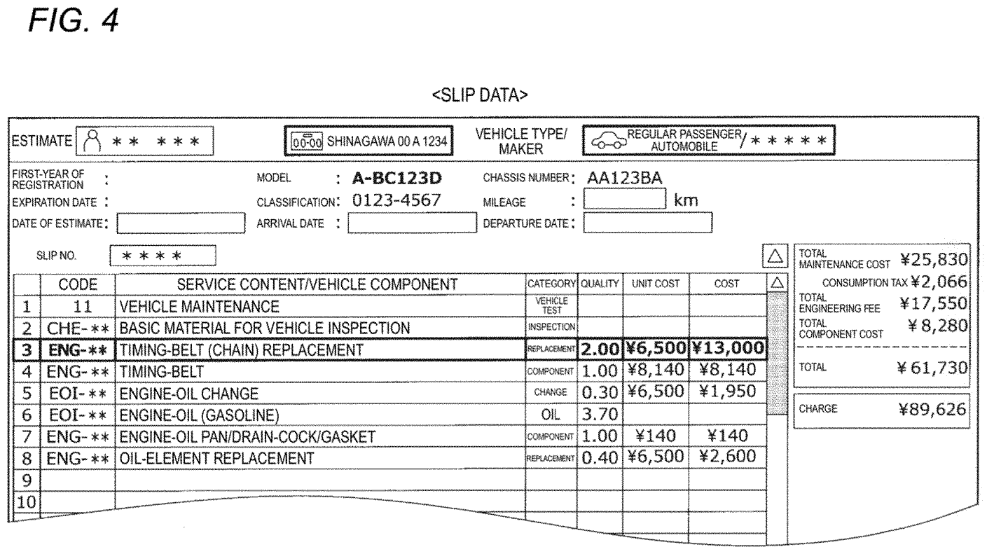

As shown in FIG. 2, in terms of functions, the vehicle maintenance support device includes, as main components, a storage unit 10 that stores “Service-Component Correspondence Data” shown in FIG. 3, “Slip Data” shown in FIG. 4, “Search Dictionary Data” and “Entry Task Log Data” and “Selected-Component Log Data” not shown in the drawing, and various programs and a variety of data, an entry task display unit 11 that receives input of a certain service content by a user's operation and displays the inputted service content on the display screen of the user terminal 100, a required-component presentation unit 12 that presents candidates for required vehicle components on the display screen, by referring to the “Service-Component Correspondence Data”, using the inputted service content as a key, a related-component presentation unit 1 that presents candidates for service contents and vehicle components related to the combinations of the service content input or selected by the user's operation and the vehicle components, according to the levels of relevance based on the degrees of co-occurrence, by referring to vehicle information input in advance by a user's operation as an attribute value, a selected-component display unit 14 that receives selection of certain vehicle components from the presented vehicle component candidates by a user's operation, and displays the selected vehicle component on the display screen in association with the service content, and an entry switch unit 15 that executes a switching operation between entry items (“Service Content”, “Vehicle Component”, and “Comment”) in response to reception of input of a predetermined key input by a user's operation,

These are configured by the CPU, the ROM, the RAM, the HDD, the communication interface, the various programs, etc.

Further, in terms of functions, the user terminal 100 also includes, as main components, a storage 110 that stores various programs and a variety of information data, a data transmitter 111 for transmitting a variety of data to the vehicle maintenance support device 1, and a data receiver 112 for receiving, a variety of data.

The “Service-Component Correspondence Data” which is stored in the storage unit 10 is table data representing the correspondence relation between service contents related to vehicle maintenance and candidates for vehicle components required depending on the service contents, as shown in FIG. 3.

In the example of FIG. 3, in association with a service content “Engine-Oil Change”, “Engine-Oil (Gasoline)” and “Engine-Oil Pan/Drain-Cock/Gasket” have been set. In other words, it can be seen that in association with the service content “Engine-Oil Change” required for vehicle maintenance as the result of inspection, the vehicle components “Engine-Oil (Gasoline)” and “Engine-Oil Pan/Drain-Cock/Gasket” have been set as candidates for vehicle components required for the corresponding service content.

As described above, it is possible to show candidates for vehicle components from service contents; however, it also is possible to show candidates for service contents from vehicle components. Specifically, it also can be seen that in association with a vehicle component “Oil Element”, a service content “Oil-Element Replacement” required for the corresponding vehicle component has been set.

“Slip Data” which is stored in the storage unit 10 is estimate data including vehicle information on vehicles, and information on service contents and vehicle components related to vehicle maintenance, for example, as shown in FIG. 4.

Specifically, slip data includes information on the vehicle type, the maker, the model, the chassis number, the classification, and the mileage, as “vehicle information”, and also includes information on specific service contents and vehicle components, the categories of service contents (such as “Inspection”, “Replacement”, “Change”, etc.), the categories of vehicle components (such as “Component”, “Oil”, etc.), and. the costs of the individual service contents and vehicle components (including the quantities and the unit costs), as “information on the service contents and the vehicle components”.

From the example of FIG. 4, it can be seen that as vehicle information, the vehicle type “Regular Passenger Automobile”, the model “A-BC123D”, and so on have been set, and it can be seen that in association with a service content “Timing-Belt (Chain) Replacement”, the category “Replacement”, the quality “2.00”, the unit cost “¥6500”, and the cost “¥13000” haven been set as information on service contents and vehicle components.

Herein, the “quantities” of service contents mean service indexes (service scores), and are numeric values representing the times required for the service contents such as replacement, change, etc. In general, each service fee is calculated by the product of the service score and the fee per worker (labor rate).

The quantities of vehicle components mean the numbers or amounts thereof, and use units such as pieces, liters, formula weights, etc.

In the storage unit 10, besides “Service-Component Correspondence Data” and “Slip Data”, “Search Dictionary Data”, “Entry Task Log Data” and “Selected-Component Log Data” are stored.

“Search Dictionary Data” is data which is a collection of information on service contents and vehicle components related to vehicle maintenance and is managed, and it is possible to refer to corresponding search dictionary data, for example, to use a function of displaying service contents to be candidates for search in the course of inputting of a service content keyword.

“Entry Task Log Data” is log data representing the history information of service contents input by user' operations, and “Selected-Component Log Data” is log data representing the history information of vehicle components selected by user's operations.

The entry task display unit 11 is a unit for receiving input of service contents by user's operations and displaying the inputted service contents on the display screen of the user terminal 100.

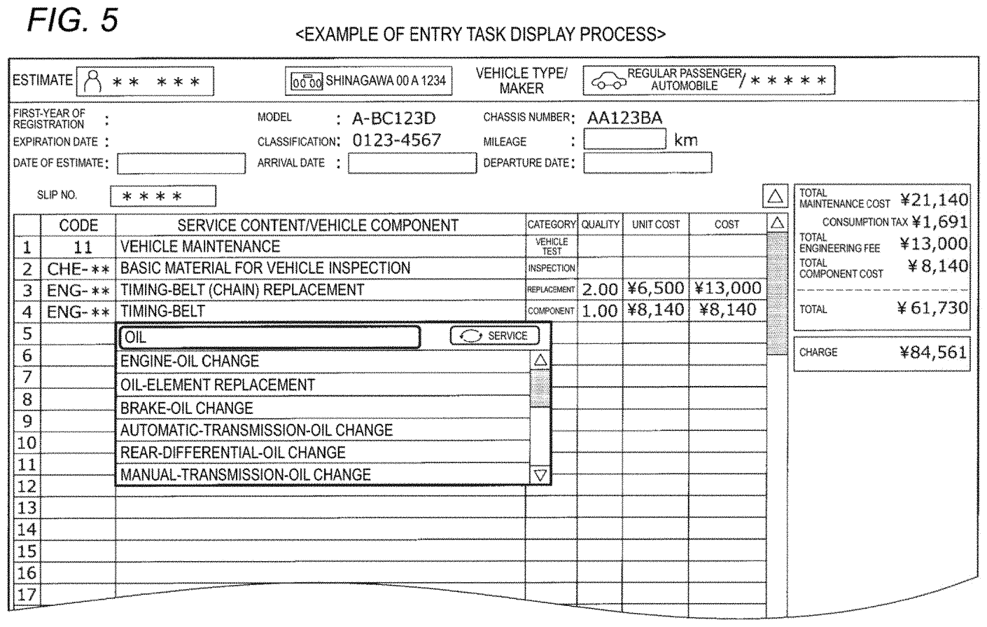

Specifically, on the slip creation screen shown in FIG. 5, first, selection of the item field “Service Content/Vehicle Component” by a user's operation is received, and a blank cell in the corresponding item field is activated. Then, when input of the service content “Oil” by a user's operation is received, the inputted service content “Oil” is displayed in the corresponding active cell.

Specifically, the entry task display unit 11 includes a user entry frequency calculator 11a and an entry candidate presentation unit 11b, as specific functional units.

The user entry frequency calculator 11a is for calculating a frequency of the user's input of each inputted service content with reference to the “Entry Task Log Data” (not shown in the drawings).

The entry candidate presentation unit 11b is for presenting service content candidates including some characters of a certain service content, with reference to the “Search Dictionary Data” (not shown in the drawings) when input of the characters by a user's operation is received. Also, the entry candidate presentation unit presents service content candidates according to their priorities based on the levels of the calculated frequencies of user's input.

Specifically, if input of the service content “Oil” by a user's operation is received, the entry candidate presentation unit 11b presents service content candidates including the inputted service content “Oil”, on the slip creation screen shown in FIG. 5. In other words, it can be seen that “Engine-Oil Change”, “Oil-Element Replacement”, and so on have been presented as corresponding service content candidates.

Also, the entry candidate presentation unit 11b presents the service content candidates according to their priorities based on the levels of the frequencies of user's input calculated by the user entry frequency calculator 11a. For example, it can be seen that of service content candidates including the service content “Oil”, the service content “Engine-Oil Change” having the highest frequency of the user's input has been presented at the top.

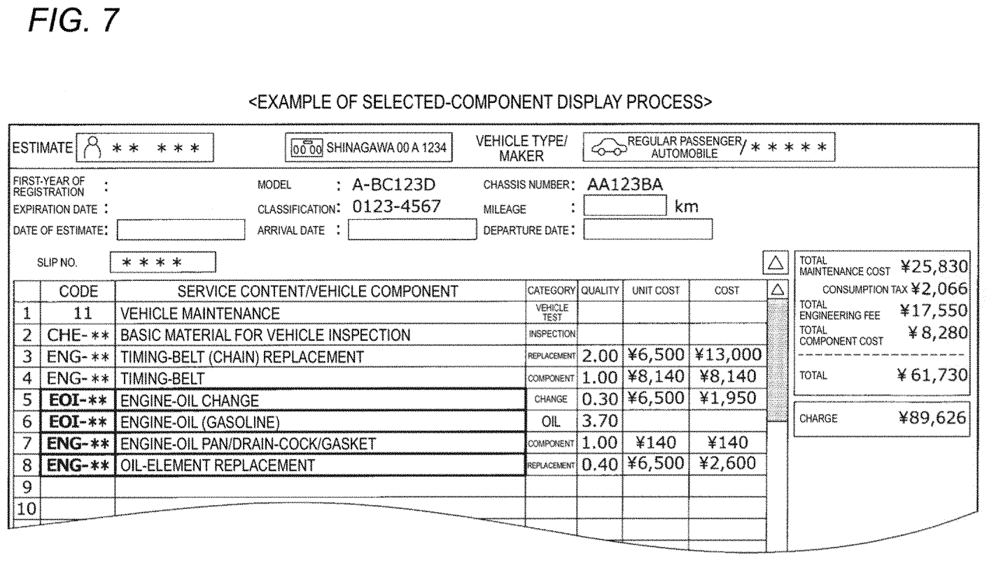

According to the above-described configuration, if receiving input (selection input) of the service content “Engine-Oil Change” by a user's operation on the slip creation screen shown in FIG. 5, the entry task display unit 11 can display the inputted service content in the active cell (see FIG. 7).

Further, it also is possible to automatically display the category “Replacement”, the quantity “0.30”, the unit cost “¥6500”, and the cost “¥1950” corresponding to the service content “Engine-Oil Change”, as shown in FIG. 7, if the corresponding service content is input. In other words, “Service-Category/Cost Correspondence Data” (not shown in the drawings) representing the correspondence relation between service contents and information on categories, quantities, unit costs, and costs corresponding to the service contents are stored in advance.

The required-component presentation unit 12 is for presenting required vehicle component candidates on the display screen by referring to the “Service-Component Correspondence Data” shown in FIG. 3, using an inputted service content as a key.

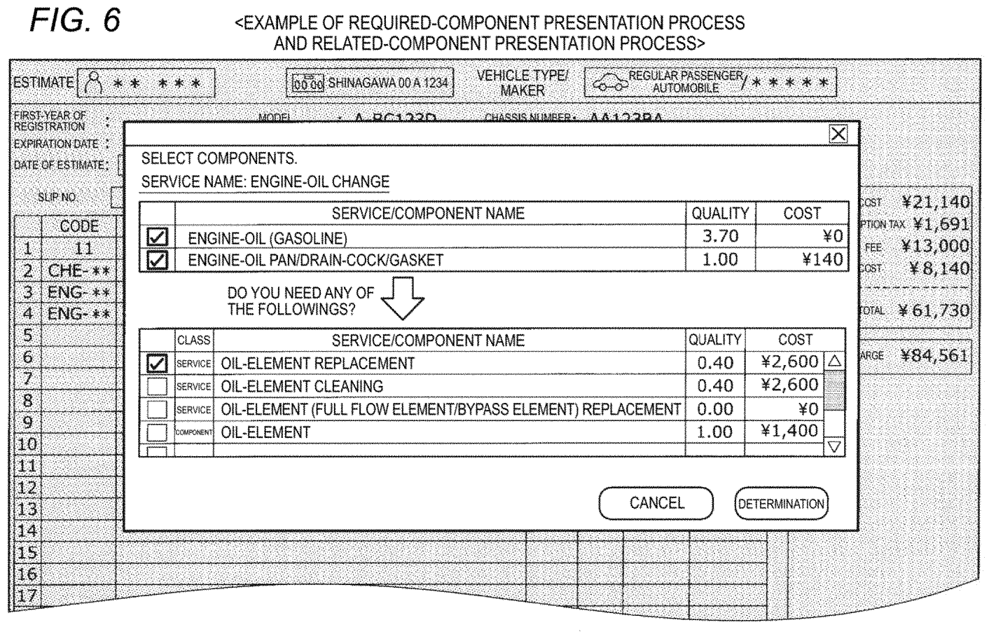

Specifically, if input of the service content “Engine-Oil Change” by a user's operation is received on the slip creation shown in FIG. 5, the required-component presentation unit refers to the “Service-Component Correspondence Data”, using the inputted service content as a key, and presents the vehicle components “Engine-Oil (Gasoline)” and “Engine-Oil Pan/Drain-Cock/Gasket” as candidates for required vehicle components, by displaying them as a pop-up on the display screen as shown in FIG. 6.

To be specific, the required-component presentation unit 12 includes a user selection frequency calculator 12a as a specific functional unit.

The user selection frequency calculator 12a is for calculating the user selection frequency of each vehicle component selected as a vehicle component required for a service content, with reference to the “Selected-Component Log Data” (not shown in the drawings).

According to this above-mentioned configuration, the required-component presentation unit 12 can present candidates for required vehicle components according to their priorities based on the user selection frequencies calculated by the user selection frequency calculator 12a. For example, it can be seen that, as shown in FIG. 6, of candidates for required vehicle components, the vehicle component “Engine-Oil (Gasoline)” having the highest priority based on the user selection frequency has been presented at the top.

In the above, the “priorities based on the user selection frequencies” may be referred to as the priorities based on the levels of the user selection frequencies; however, in the case where it is desired to present more accurate vehicle component candidates for each user, their priorities may be determined by the flow of the following learning process.

Step 1: Calculate the “user selection frequency” of each of vehicle components selected as vehicle components required for a predetermined service content, with reference to the selected-component log data (not shown in the drawings).

Step 2: Determine the priorities by scoring evaluation using the “user selection frequencies” and “additional values of the user”

The “additional values of the user” mean the priorities (priority indexes) set for vehicle components in advance by the user.

The “scoring evaluation” is to score (digitalize) each of evaluation objects and execute addition or subtraction on the scores under a plurality of conditions, and rearrange the evaluation objects in the descending order of the scores.

The related-component presentation unit 13 is for presenting candidates for service contents (vehicle components) related to the combinations of a service content input selected by a user's operation and vehicle components, on the display screen, according to the levels of relevance based on the degrees of co-occurrence, by referring to the vehicle information input as an attribute value in advance by a user's operation.

Specifically, if receiving selection of the vehicle components “Engine-Oil (Gasoline)” and “Engine-Oil Pan/Drain-Cock/Gasket” on the popup screen shown in FIG. 6 by a user's operation, the related-component presentation unit further presents candidates for related service contents (vehicle components) with respect to the combinations with the service content “Engine-Oil Change” input previously by the user's operation, on the popup screen. For example, as candidates for related service contents (vehicle components), the service content “Oil-Element Replacement”, the vehicle components “Oil Element”, and so on have been presented.

To be specific, the related-component presentation unit 13 includes a service-component relevance calculator 13a

The service-component relevance calculator 13a is for counting a frequency of use of each of service contents and vehicle components in each vehicle information item with reference to a plurality of “past slip data items” (not shown in the drawings), and calculating the degrees of relevance based on the degrees of co-occurrence between the service contents and the vehicle components in the vehicle information item.

According to the above-mentioned configuration, the related-component presentation unit 13 can present candidates for service contents (vehicle components) related to the combinations of a service content input selected by a user's operation and vehicle components, on the display screen, in the descending order of the degrees of relevance based on the degrees of co-occurrence and calculated by the service-component relevance calculator 13a, by referring to the vehicle information input previously by a user's operation, as an attribute value. For example, it can be seen that as shown in FIG. 6, the service content “Oil-Element Replacement” having the highest degree of relevance based on the degree of co-occurrence is presented as a candidate for related service contents (vehicle components) at the top.

By the way, it is desirable to use, for example, the vehicle type or the vehicle model as the “vehicle information” to be an attribute value (a search condition).

In the above, in the case where it is desired to present candidates for related service contents (vehicle components) in the descending order of the degrees of accuracy for each user, the priorities may be determined by the flow of the following learning process.

Step 1: Vectorize the service contents and the vehicle components to be included in the slip data, using the vehicle information as an attribute value.

Step 2: Learn the degrees of co-occurrence and the degrees of relevance between the service contents and the vehicle components, using a co-occurrence network.

Step 3: Present service contents (vehicle components) related to the designated vehicle information, the designated service content, and the designated vehicle component (having high degrees of co-occurrence) in the descending order of the degrees of relevance.

To create a learning model, not only a BL creation thesaurus, Tensorflow (registered as a trade mark), and word2vec, but also specific learning algorithms for executing learning using a variety of structure data of vehicles and big data obtained by vehicles and vehicle maintenance tasks are used.

“Vectorizing” is executing conversion into vector values such as numeric values, determinants, and the like in order to learn character data. The vectorizing makes it possible to determine the distance (degree of relevance), the degree of similarity, or the like of each character data item by numeric values.

“Learning the degrees of co-occurrence and the degrees of relevance” means learning using a method of automatically determining the meaningful hierarchical relations between words.

Also, in the above, the related-component presentation unit 13 can present candidates for related service-component sets on the popup screen shown in FIG. 6, besides candidates for related service contents or vehicle components.

As related service-component sets, sets of service contents and vehicle components are presented; however, sets each of which is composed of service contents, and sets each of which is composed of vehicle components may be presented.

The selected-component display unit 14 is for receiving selection of certain vehicle components from the presented vehicle component candidates by a user's operation and displaying the selected vehicle components on the display screen in association with service contents.

Specifically, if receiving selection of the vehicle components “Engine-Oil (Gasoline)” and “Engine-Oil Pan/Drain-Cock/Gasket” on the popup screen shown in FIG. 6 by user's operations, the selected-component display unit displays the selected vehicle components on the slip creation screen in association with the service content “Engine-Oil Change”, as shown in FIG. 7.

Specifically, the selected-component display unit 14 displays information on each vehicle component in the item field “Service Content/Vehicle Component” such that it is to arranged together with the corresponding service content in a row, and is indented with respect to the service content.

Further, it can be seen from the example of FIG. 7 that the vehicle component “Timing-Belt” has been displayed so as to be indented with respect to the service content “Timing-Belt (Chain) Replacement”.

The entry switch unit 15 is for executing an operation of switching between entry items (“Service Content”, “Vehicle Component”, and “Comment”) on the display screen if receiving input of a predetermined key by a user's operation.

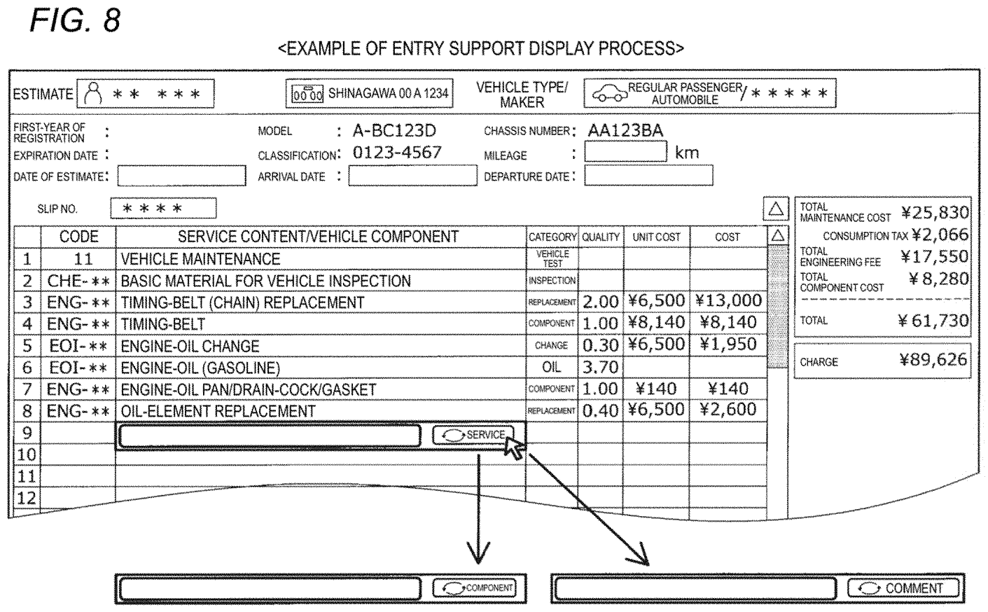

Specifically, if receiving input of a predetermined shortcut key by a user's operation on a slip creation display screen shown in FIG. 8, the entry switch unit executes a switching operation from an entry item “Service (Service Content)” to an entry item “Component (Vehicle Component)” or an entry item “Comment”.

For example, when switching from the entry item “Service” to the entry item “Component”, the entry switch unit switches the active cell from the cell in the entry item “Service” shown in FIG. 8 to a cell in the entry item “Component”.

When the entry item “Component” is set, if receiving input of a certain vehicle component by a user's operation, the entry switch unit can display the input vehicle component on the slip creation display screen. Also, if inputting a keyword of a vehicle component, it is possible to present vehicle component candidates including the corresponding keyword with reference to the “Search Dictionary Data” related to vehicle components.

<Vehicle Maintenance Support Program>

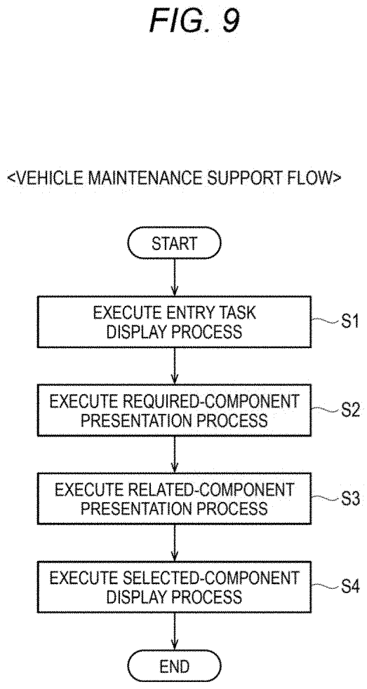

Now, the processing of the vehicle maintenance support program which is executed by the vehicle maintenance support device 1 will be described on the basis of FIG. 9.

The above-mentioned program of the present embodiment is a utility program configured by aggregating various programs in order to implement the entry task display unit 11, the user entry frequency calculator 11, a the entry candidate presentation unit 11b, the required-component presentation unit 12, the user selection frequency calculator 12a, the related-component presentation unit 13, the service-component relevance calculator 13a, and the selected-component display unit 14 described above as functional components of the vehicle maintenance support device 1 having the storage unit 10, and the CPU of the vehicle maintenance support device 1 executes this vehicle maintenance support program.

The above-mentioned program is executed in response to reception of an operation instruction from the user.

The storage unit 10 of the vehicle maintenance support device 1 stores the “Service-Component Correspondence Data” shown in FIG. 3, the “Slip Data” shown in FIG. 4, and the “Search Dictionary Data” and “Entry Task Log Data” and “Selected-Component Log Data” (not shown in the drawings).

In a vehicle maintenance support process flow shown in FIG. 9, first, the entry task display unit 11 starts with STEP S1 of receiving input of a certain service content by a user's operation and displaying the inputted service content on the display screen of the user terminal 100.

Specifically, if receiving input of the service content “Oil” by a user's operation on the slip creation screen shown in FIG. 5, the entry candidate presentation unit 11b presents service content candidates including the inputted service content “Oil”.

At this time, the entry candidate presentation unit 11b presents the service content candidates according to the priorities based on the levels of the frequencies of user's input calculated by the user entry frequency calculator 11a. For example, the entry candidate presentation unit presents the service content “Engine-Oil Change” having the highest frequency of the user's input, of the service content candidates including the service content “Oil”, at the top.

In the above, if receiving input (selection) of the service content “Engine-Oil Change” by a user's operation, the entry task display unit 11 displays the inputted service content in an active cell.

Subsequently, in STEP S2, the required-component presentation unit 12 presents candidates for required vehicle components on the display screen, by referring to the “Service-Component Correspondence Data” shown in FIG. 3, using the inputted service content as a key.

Specifically, if receiving input of the service content “Engine-Oil Change” by a user's operation on the slip creation screen shown in FIG. 5, the required-component presentation unit presents the vehicle components “Engine-Oil (Gasoline)” and the “Engine-Oil Pan/Drain-Cock/Gasket” on the display screen as candidates for required vehicle components as shown in FIG. 6, by referring to the “Service-Component Correspondence Data”, using the inputted service content as a key.

At this time, the user selection frequency calculator 12a calculates the frequencies of the user's input of the individual vehicle components selected as vehicle components required for the predetermined service content with reference to the “Selected-Component Log Data” (not shown in the drawings).

In the above, the required-component presentation unit 12 presents the candidates for required vehicle components on the display screen, according to the priorities based on the user selection frequencies calculated by the user selection frequency calculator 12a. For example, as shown in FIG. 6, the vehicle component “Engine-Oil (Gasoline)” having the highest priority based on the user selection frequency is presented at the top.

Subsequently, in STEP S3, the related-component presentation unit 13 presents candidates for service contents (vehicle components) related to the combinations of the service content and the vehicle components input or selected by a user's operation, according to the levels of relevance based on the degrees of co-occurrence, by referring, to the vehicle information input in advance by a user's operation as an attribute value.

Specifically, if receiving selection of the vehicle components “Engine-Oil (Gasoline)” and “Engine-Oil Pan/Drain-Cock/Gasket” by a user's operation on the popup screen shown in FIG. 6, the related-component presentation unit presents candidates for related service contents (vehicle components) with respect to the combinations with the service content “Engine-Oil Change” input previously by the user's operation, on the popup screen. For example, the related-component presentation unit presents the service content “Oil-Element Replacement” and the vehicle components “Oil Element” and so on, as candidates for related service contents (vehicle components).

At this time, the service-component relevance calculator 13a counts a frequency of use of each of service contents and vehicle components in each vehicle information item with reference to a plurality of “past slip data items” (not shown in the drawings), and calculates the degrees of relevance based on the degrees of co-occurrence between the service contents and the vehicle components in the vehicle information item.

In the above, the related-component presentation unit 13 presents candidates for service contents (vehicle components) related to the combinations of a service content input selected by a user's operation and vehicle components, on the display screen, according to the descending order of the degrees of relevance based on the degrees of co-occurrence and calculated by the service-component relevance calculator 13a, by referring to the vehicle information input previously by a user's operation, as an attribute value.

For example, the related-component presentation unit presents the service content “Oil-Element Replacement” having the highest degree of relevance based on the degree of co-occurrence at the top, as shown in FIG. 6.

Finally, in STEP S4, the selected-component display unit 14 receives selection of vehicle components from the presented vehicle component candidates by a user's operation and displays the selected vehicle components in association with service contents on the display screen.

Specifically, if receiving selection of the vehicle components “Engine-Oil (Gasoline)” and “Engine-Oil Pan/Drain-Cock/Gasket” on the popup screen shown in FIG. 6 by a user's operation, the selected-component display unit displays the selected vehicle components on the slip creation screen in association with the service content “Engine-Oil Change”, as shown in FIG. 7.

To be specific, the selected-component display unit 14 displays information on the vehicle components on the slip creation screen, so as to be indented with respect to the service content, as shown in FIG. 7.

Further, it can be seen from the example of FIG. 7 that in addition to the above-mentioned service components selected as required service components, the service content “Oil-Element Replacement” selected as a related service content is also displayed.

After STEP S1 to STEP S4, the process of FIG. 9 is ended.

By the configuration of the vehicle maintenance support program described above, it becomes possible for the user such as a maintenance business operator to efficiently create slip data on the display screen of the user terminal 100.

Also, it becomes easy for the user to grasp the relation between service contents and vehicle components required depending on the service contents when creating slip data on the display screen.

### Other Embodiments

In the above-described embodiment, the vehicle maintenance support device 1 has the configuration in which if receiving input of a certain service content by a user's operation, the vehicle maintenance support device presents candidates for required vehicle components and candidates for related vehicle components (service contents), respectively, using the inputted service content as a key; however, the present invention is not particularly limited thereto, and the vehicle maintenance support device may present candidates for required service contents from a certain vehicle component.

To be specific, the vehicle maintenance support device 1 may be configured such that if receiving input of a vehicle component by a user's operation, the vehicle maintenance support device presents candidates for required service contents and candidates for related service contents (vehicle components), using the input vehicle component as a key.

In the above-described embodiment, the vehicle maintenance support device 1 stores the vehicle maintenance support program in a readable recording medium in advance, and the vehicle maintenance support device 1 reads and executes the vehicle maintenance support program, whereby the process is executed. Herein, recording media which the vehicle maintenance support device 1 can read are magnetic disks, micro-optical disks, CD-ROMs, DVD-ROMs, semiconductor memories, etc. Also, the vehicle maintenance support device may be configured to transmit the vehicle maintenance support program to the user terminal 100 by a communication line, such that the user terminal 100 receiving the transmission can execute the program.

In the above-described embodiments, the vehicle maintenance support device, the vehicle maintenance support method, and the vehicle maintenance support program according to the present invention have been mainly described.

However, the above-described embodiments are merely examples for facilitating understanding of the present invention, and do not limit the present invention. It is obvious that the present invention can be changed and modified without departing from the gist thereof and the present invention includes equivalents thereof.

### REFERENCE SIGNS LIST

S Vehicle Maintenance Support System

1 Vehicle Maintenance Support Device

10 Storage Unit

11 Entry Task Display Unit

11a User Entry Frequency Calculator

11b Entry Candidate Presentation unit

12 Required-Component Presentation Unit

12a User Selection Frequency Calculator

13 Related-Component Presentation Unit

13a Service-Component Relevance Calculator

14 Selected-Component Display Unit

15 Entry Switch Unit

100 User Terminal

110 Storage Unit

111 Data Transmitter

112 Data Receiver

1. A vehicle maintenance support device for supporting creation of slips related to vehicle maintenance, comprising:
a storage unit configured to store service-component correspondence data representing a correspondence relation between service contents related to the vehicle maintenance, and candidates for vehicle components required depending on the service contents;
an entry task display unit configured to receive input of a certain service content by a user's operation, and display inputted service content on a display screen of a user terminal;
a required-component presentation unit configured to present candidates for required vehicle components on the display screen, by referring to the service-component correspondence data, using the inputted service content as a key; and
a selected-component display unit configured to receive selection of certain vehicle components from the presented vehicle component candidates by the user's operation, and display the selected vehicle components on the display screen in association with the service content.

2. The vehicle maintenance support device according to claim 1, wherein
the selected-component display unit is configured to display information on each of the vehicle components on the display screen such that it is arranged together with the service content in a row, and display information on the vehicle components so as to be indented with respect to the service content.

3. The vehicle maintenance support device according to claim 1, wherein
the storage unit is configured to store selected-component log data representing history information of the vehicle components selected by user's operations,
the vehicle maintenance support device further includes a user selection frequency calculator configured to calculate user selection frequencies of individual vehicle components selected as vehicle components required for a certain service content, with reference to the selected-component log data, and
the required-component presentation unit is configured to present candidates for required vehicle components on the display screen, according to priorities based on the calculated user selection frequencies.

4. The vehicle maintenance support device according to claim 1, wherein
the storage unit is configured to store a plurality of past slip data items including vehicle information on vehicles, information on the service contents and the vehicle components related to vehicle maintenance,
the vehicle maintenance support device further includes
a service-component relevance calculator configured to count a frequency of use of each of the service contents and the vehicle components, with reference to the plurality of slip data items, and calculate degrees of relevance based on degrees of co-occurrence between the service contents and the vehicle components in each vehicle information item, and
a related-component presentation unit configured to present candidates for service contents and/or vehicle components related to the combinations of the service content inputted or selected by the user's operation and the vehicle components on the display screen, according to levels of calculated relevance based on the degrees of co-occurrence, by referring to the vehicle information inputted in advance by a user's operation as an attribute value, and
the related-component presentation unit is configured to present candidates for related service contents and/or vehicle components in a descending order of the degrees of calculated relevance based on the degrees of co-occurrence.

5. The vehicle maintenance support device according to claim 1, wherein
the storage unit is configured to store search dictionary data related to the service contents, and entry task log data representing history information of service contents inputted by user's operations,
the vehicle maintenance support device further includes
a user selection frequency calculator configured to calculate a frequency of the user's input of each inputted service content with reference to the entry task log data, and
an entry candidate presentation unit configured to present service content candidates including some characters of a certain service content with reference to the search dictionary data when receiving input of the some characters by the user's operation, and
the entry candidate presentation unit is configured to present the service content candidates according to priorities based on the calculated frequencies of user's input.

6. A vehicle maintenance support method for supporting creation of slips related to vehicle maintenance, wherein
a computer including a storage unit storing service-component correspondence data representing a correspondence relation between service contents related to the vehicle maintenance, and candidates for vehicle components required depending on the service contents executes a process comprising:
an entry task display process for receiving input of a certain service content by a user's operation, and displaying the inputted service content on a display screen of a user terminal;
a required-component presentation process for presenting candidates for required vehicle components on the display screen, by referring to the service-component correspondence data, using the inputted service content as a key; and
a selected-component display process for receiving selection of certain vehicle components from the presented vehicle component candidates by the user's operation, and displaying the selected vehicle components on the display screen in association with the service content.

7. A computer-readable non-transitory medium storing a vehicle maintenance support program for making a computer serving as a vehicle maintenance support device for supporting creation of a slip related to vehicle maintenance execute a process, the process comprising:
an entry task display process for receiving input of a certain service content by a user's operation, and displaying the inputted service content on a display screen of a user terminal;
a required-component presentation process for presenting candidates for required vehicle components on the display screen, by referring to service-component correspondence data representing a correspondence relation between service contents related to the vehicle maintenance and candidates for vehicle components required depending on the service contents, using the inputted service content as a key; and
a selected-component display process for receiving selection of certain vehicle components from the presented vehicle component candidates by the user's operation, and displaying the selected vehicle components on the display screen in association with the service content.
